(19) United States
(12) Patent Application Publication
(10) Pub. No.: US 2009/0002640 A1
(43) Pub. Date: Jan. 1, 2009

(54) DISPLAY DEVICE AND METHOD USING LASER LIGHT SOURCES AND RECORD MEDIA RECODED PROGRAM REALIZING THE SAME

(75) Inventors: Haeng-Seok Yang, Bucheon-si (KR); Sung-Kyong Oh, Suwon-si (KR); Eui-Joong Kim, Suwon-si (KR); Byoung-Ki Song, Suwon-si (KR); Joo-Hong Kim, Hwaseong-si (KR); Sung-Ho Byun, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/163,424

(22) Filed: Jun. 27, 2008

(30) Foreign Application Priority Data
Jun. 27, 2007 (KR) 10-2007-0063901

(51) Int. Cl. G03B 21/20

(52) U.S. Cl. 353/31; 353/122; 353/52

(57) ABSTRACT

A display device includes a red laser light source which irradiates light in wavelength range of 636 nm to 645 nm; and a light projector which modulates and project the light on screen. With a display device according to embodiments of the present disclosure, the projected image may be by using three laser light sources which irradiate red, green and blue light each of which wavelengths is limited to 636 nm to 645 nm, 520 nm to 532 nm or 430 nm to 454 nm.

### CROSS-REFERENCE TO RELATED APPLICATIONS

This application claims the benefit of Korean Patent Application No. 10-2007-0063901 filed with the Korean Intellectual Property Office on Jun. 27, 2007, the disclosures of which are incorporated herein by reference in their entirety.

### BACKGROUND

1. Technical Field

The present invention is related to a display device and method using laser light sources, more specifically to a device and method for projecting a picture on a screen by using each laser source which can irradiate red, green and blue color light, respectively in a particular wavelength region

2. Description of the Related Art

Previously, for two purposes which are to get a wide color representability and control of radiation power, red color, green color and blue color wavelength have been adjusted in a device using laser light sources.

However, because each region of red, green and blue wavelength is adjusted to get a wide color representability and control of radiation power, it cannot be adjusted to provide maximum color representability and because each region is adjusted only in a limited range, a device exhibits a limited color representability.

And another problem of prior art is that red light being irradiated from red color laser light source is very sensitive to temperature because power of red light is changed and wavelength of red light is shifted with rising of temperature.

Once power and wavelength of red light is changed or shifted, it not only deteriorates color representability but also significantly reduces the quality of a projected image because the device cannot project a constant contrast image on a screen.

### SUMMARY

Contrived to solve the aforementioned problems, the present invention provides a display device and method using laser light sources that have more improved color representability by limiting red, green, blue light wavelength range and can minimize change of red light power and shift of red light wavelength by guaranteeing temperature stability of red light and project a proper contrast image on a screen.

A display device includes: a red laser light source which irradiates light in the wavelength range of 636 nm to 645 nm; and a light projector which modulates and projects the light on a screen.

Here, the display device can further include a blue laser light source which irradiates light in the wavelength range of 430 nm to 454 nm.

Also, the display device can further include a green laser light source which irradiates light in the wavelength range of 520 nm to 532 nm.

The light projector can include an optical modulator which diffracts and reflects the light.

The display device can further include an expander which expands the light which a red laser light source irradiates; a collimator which collimates the light which the expander expands; and a line shaped light generator which receives the collimated light and output one dimensional line shaped light; wherein the one dimensional line shaped light is inserted to the light projector.

The display device can further include a blue laser light source which irradiates light in the wavelength range of 430 nm to 454 nm; a green laser light source which irradiates light in the wavelength range of 520 nm to 532 nm; first and second collimators; and first and second reflectors; wherein each light irradiated from the red laser light source and the blue laser light source passes through the first and second collimators, respectively and is reflected by the first and second reflectors, respectively and passes through the line shaped light generator and the light which irradiated from the green laser light source passes through the expander.

The light projector can include an optical modulator which receives light, modulates the brightness of the light by diffracting and reflecting, and outputs the modulated light; and project lens which project the outputted modulated light on the screen.

The display device can further include a wavelength controller that adjusts a wavelength range of light which is irradiated from at least one of red, green and blue laser light source.

The display device can further include an optical modulator which receives light, modulates the brightness of the light by diffracting and reflecting, and outputs the modulated light; and a temperature sensor; wherein the wavelength controller adjusts a wavelength range of the light which is irradiated from at least one of red, green and blue laser light source, corresponding to the temperature that the temperature sensor estimates.

Contrived to solve the aforementioned problems, the present invention provides a method at a display device for displaying a projected image on a screen by using laser light sources, the method including: estimating inner or outer temperature of the display device at a temperature sensor which is included in the display device; and outputting a control signal to a wavelength controller in the display device for adjusting a wavelength range of the light outputted from a laser light source when the temperature estimated by the temperature sensor is higher than a predetermined critical temperature; wherein in case that a laser light source irradiates red light, the wavelength is adjusted within the range of 636 nm to 645 nm, in case that a laser light source irradiates green light, the wavelength is adjusted within the range of 520 nm to 532 nm, and in case that a laser light source irradiates blue light, the wavelength is adjusted within the range of 430 nm to 454 nm.

Contrived to solve the aforementioned problems, the present invention record medium that can be accessed by a computer which stores a program for a method at a display device for displaying a projected image on screen by using laser light sources, the method including: estimating inner or outer temperature of the display device at a temperature sensor which is included in the display device; and outputting a control signal to a wavelength controller in the display device for adjusting a wavelength range of the light outputted from a laser light source when the temperature estimated by the temperature sensor is higher than a predetermined critical temperature; wherein in case that a laser light source irradiates red light, the wavelength is adjusted within the range of 636 nm to 645 nm, in case that a laser light source irradiates green light, the wavelength is adjusted within the range of 520 nm to 532 nm, and in case that a laser light source irradiates blue light, the wavelength is adjusted within the range of 430 nm to 454 nm.

### BRIEF DESCRIPTION OF THE DRAWINGS

FIG. 1 shows a display device in accordance with an embodiment of the present invention.

FIG. 2 shows a micromirror in an optical modulator that is included in a display device in accordance with an embodiment of the present invention.

FIG. 3 shows an optical modulator that is included in a display device in accordance with an embodiment of the present invention.

FIG. 4 is a schematic diagram illustrating an image generated on a screen by a diffraction type optical modulator array applicable to an embodiment of the invention.

FIG. 5 shows a XY chromaticity diagram that indicates the color which is represented corresponding to a light laser source in accordance with the present invention.

FIG. 6 shows shifts of wavelength with changing temperature.

FIG. 7 is a flowchart that indicates the procedure of estimating temperature and adjusting light wavelength.

### DETAILED DESCRIPTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

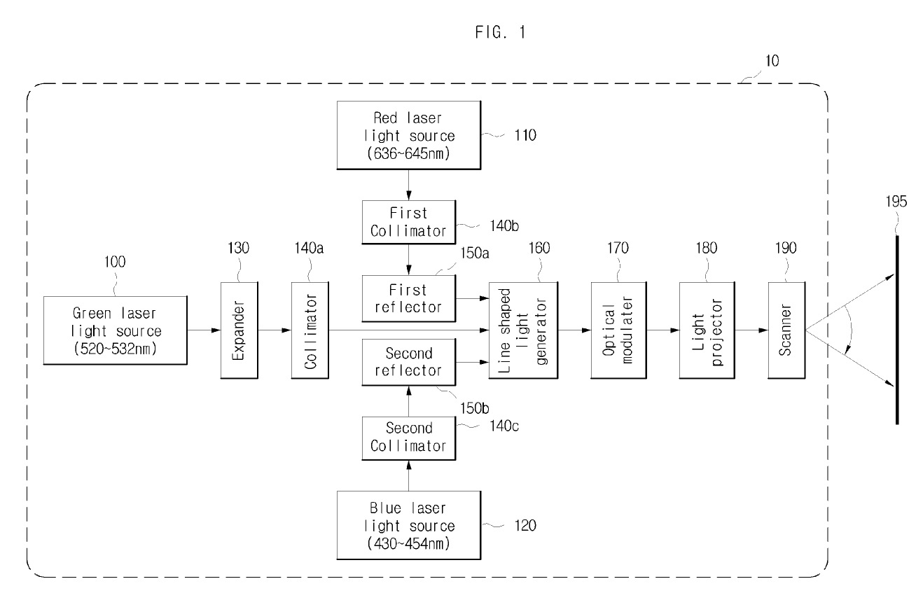

FIG. 1 shows a display device in accordance with an embodiment of the present invention.

Referring to FIG. 1, a display device 10 in accordance with an embodiment of the present invention includes a green color laser light source 100, a red laser light source 110, a blue color laser light source 120, a light expander 130, collimators 140a, 140b, 140c, first and second reflectors 150a, 150b, a line shaped light generator 160, an optical modulator 170, a light projector 180 and a scanner 190.

The green color laser light source 100, the red laser light source 110, the blue color laser light source 120 are independent light sources. Each of the laser light sources 100, 110, 120 may be a semiconductor laser, a solid laser, a gas laser or a liquid laser and is not limited to them.

In a display device 10 in accordance with an embodiment of the present invention, the green light irradiated from the green laser light source 100 is expanded to a specific degree with passing through the light expander 130. In this case, the light expander can include a light expanding lens.

The expanded green light is collimated by passing through the collimator 140a to the parallel green light and inserted into the line shaped light generator 160. In this case, the collimator 140a can include a collimating lens. The parallel green light being inserted is transformed to a one dimensional line shaped light by passing through the line shaped light generator 160. The line shaped light generator 160 can include more than one lens and prism and light being inserted to the line shaped light generator 160 is transformed and outputted in line shaped light.

And, red light and blue light irradiated from the blue laser light source 110 and the blue laser light source 120 each is collimated into parallel light by passing through the collimator 140a and 140c, respectively located close to each laser light source 110, 120. In this case, the collimator 140a or 140c can include a collimating lens.

The parallel red light and blue light are reflected by the first and the second reflector 150a, 150b, respectively and inserted to the line shaped light generator 160 and transformed to line shaped light.

An inserting route of green light to the line shaped light generator 160 is different from that of red light or blue light because NA (Numerical Aperture) of green light is relatively smaller than those of red or blue light and therefore green light is to pass through the light expander 130 and the collimator 140a. However, the display device 10 according to an embodiment of the invention is only an example and it is apparent that arrangement of green, red, blue laser source 100, 110, 120 be different from that in FIG. 1.

Each color light is transformed to line shaped light for the purpose of being inserted to the optical modulator 170. The optical modulator 170 is a line shape which has a plurality of micromirrors arranged in one dimensional array.

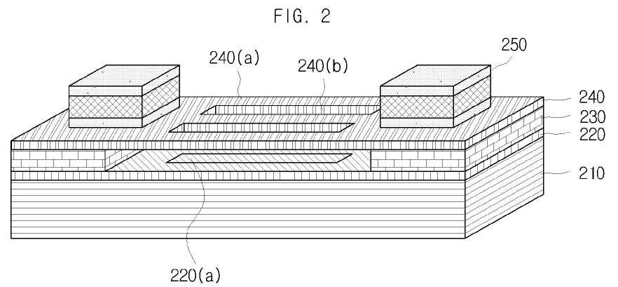

Each micromirror is corresponding to each pixel in an image being displayed on a screen and the optical modulator 170 is a line shape which has a plurality of micromirrors arranged in one dimensional array. In order that each micromirror corresponds to one pixel, it includes a upper reflecting layer and lower reflecting layer and the structure of each micromirror is to be described referring to FIG. 2.

Therefore, not if dot shaped light is inserted to each micromirror but if each red, green and blue line shape light is inserted time-divisionally to the line shaped optical modulator 170, each micromirror modulates light and the line shaped optical modulator 170 can output a one dimensional line shaped light.

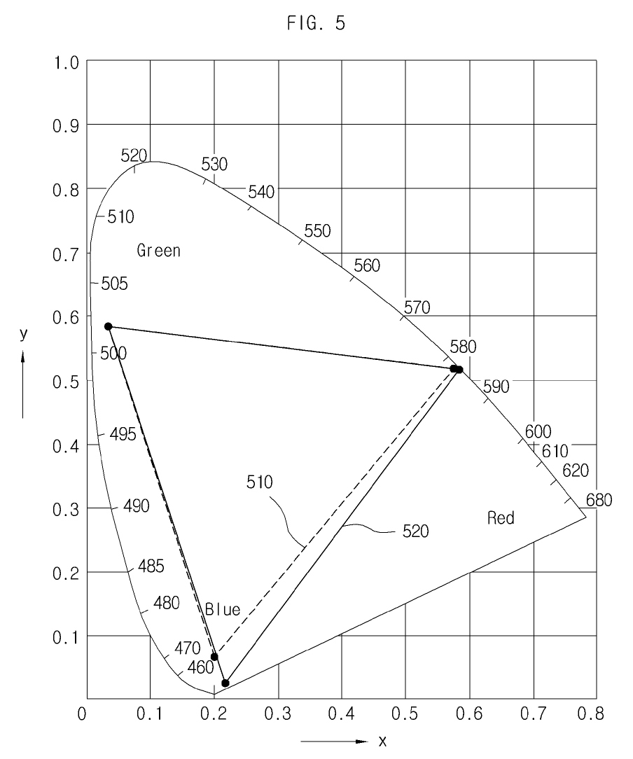

Wavelengths of red, green and blue light is in the range of 636 nm to 645 nm, 520 nm to 532 nm, 430 nm to 454 nm, respectively. Each wavelength of light is described more detail referring to FIG. 5.

Modulated light from entire optical modulator 170 is represented as one scanning line. This scanning line is scanned sequentially and be able to complete a two-dimensional plane image.

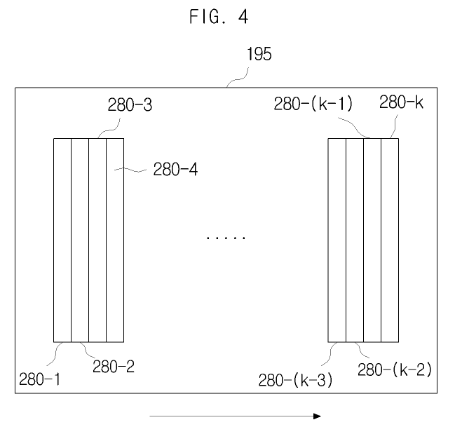

Modulated light from entire optical modulator 170 goes through the light projector 180 and inserted to the scanner 190 and the scanner 190 projects a line shaped and modulated light on a screen sequentially to make a two-dimensional plane image. The scanner 190 reflects the modulated light from the entire optical modulator 170 in a predetermined angle and projects it on the screen 195. For example, once a line shaped and modulated light from the vertical directioned optical modulator 170 is scanned from left side to right side, a two-dimensional plane image is completed. This is to be described more detail referring to FIG. 4.

In this case, a predetermined angle is determined by a scanner control signal input from a image control module (not in picture). The scanner control signal is synchronized with an image control signal and the scanner is rotated in the angle which makes a line shaped and modulated light be projected on a horizontal or vertical scanning line location of the screen 195 corresponding to the image control signal. The scanner control signal includes drive angle and drive velocity information and the scanner 190 is at a specific location and at a specific time correspondingly to drive angle and drive velocity. The scanner 190 can be a polygon mirror, a rotating bar or a galvano mirror.

Not described in FIG. 1, an image control module can control each laser light source 100, 110, 120, the optical modulator 170 and the scanner 190. The image control module can include a micro processor and be connected to each element in a display device electrically and can transmit a control signal to each element.

For example, each laser light source 100, 110, 120 can receive a source control signal from an image control module and adjust wavelength range of light being irradiated. In this case, each laser light source 100, 110, 120 can include a wavelength controller. A wavelength controller additionally can adjust wavelength range of light correspondingly to surrounding environment by receiving a wavelength control signal from an image control module.

And an image control module can transmit a scanner control signal to a scanner 190 and can control a modulated and line shaped light from an optical modulator 170 to be scanned from left side to right side like aforementioned description.

And an image control module can modify a location of each micromirror correspondingly to an image signal and control it for one dimensional image with proper brightness to be generated.

FIG. 2 shows a micromirror in an optical modulator that is included in a display device.

In FIG. 2 is illustrated one micromirror among a plurality of micromirrors arranged in a row included in the optical modulator 170, it includes a substrate 210, an insulation layer 220, a sacrificial layer 230, a ribbon structure 240, and piezoelectric elements 250.

The substrate 210 is a commonly used semiconductor substrate, and the insulation layer 220 is deposited as an etch stop layer. The insulation layer 220 is formed from a material with a high selectivity to the etchant (the etchant is an etchant gas or an etchant solution) that etches the material used as the sacrificial layer. Here, the reflective layers 220(a) may be formed on the insulation layer 220 to reflect incident beams of light.

The sacrificial layer 230 supports the ribbon structure 240 such that the ribbon structure is displaced by a particular gap from the insulation layer 220, and forms a space in the center.

The ribbon structure 240 creates diffraction and interference in the incident light to provide optical modulation of signals as described above. The form of the ribbon structure 245 may be composed of a plurality of ribbon shapes according to the electrostatic type, and may include a plurality of open holes in the center portion of the ribbons according to the piezoelectric type. The piezoelectric elements 250 control the ribbon structure 240 to move vertically, according to the degree of up/down or left/right contraction and expansion generated by the difference in voltage between the upper and lower electrodes. Here, the reflective layers 220(a) are formed in correspondence with the holes 240(b) formed in the ribbon structure 245.

For example, in the case where the wavelength of a beam of light is λ, there is a first amount of power supplied, which make the gap between an upper reflective layer 240(a) formed on the ribbon structure and a lower reflective layer 220(a) which is formed on the insulation layer 220 equal to nλ/2 (wherein n is a natural number). In this case that a 0-order diffracted (reflected) beam of light, the overall path length difference between the light reflected by the upper reflective layer 240(a) and the light reflected by the lower reflective layer 220(a) is equal to nλ, so that constructive interference occurs and the diffracted light is rendered its maximum luminosity. In the case of +1 or −1 order diffracted light, however, the luminosity of the light is at its minimum value due to destructive interference.

Also, an second amount of power is supplied to the piezoelectric elements 220 which make the gap between an upper reflective layer 240(a) formed on the ribbon structure and a lower reflective layer 220(a) which is formed on the insulation layer 220 become (2n+1)λ/4 (wherein n is a natural number). In this case that a 0-order diffracted (reflected) beam of light, the overall path length difference between the light reflected by the upper reflective layer 240(a) and the light reflected by a lower reflective layer 220(a) is equal to (2n+1)λ/2, so that destructive interference occurs, and the diffracted light is rendered its minimum luminosity. In the case of +1 or −1 order diffracted light, however, the luminosity of the light is at its maximum value due to constructive interference.

As a result of such interferences, the optical modulator can load signals on the light by controlling the quantity of the reflected or diffracted light.

While the foregoing describes the cases in which the gap between the ribbon structure 240 and the insulation layer 220 is nλ/2 or (2n+1)λ/4, it is obvious that a variety of embodiments may be applied with regards the present invention which are operated with gaps that allow the control of the interference by diffraction and reflection.

The descriptions below will focus on the type of optical modulator illustrated in FIG. 2 described above.

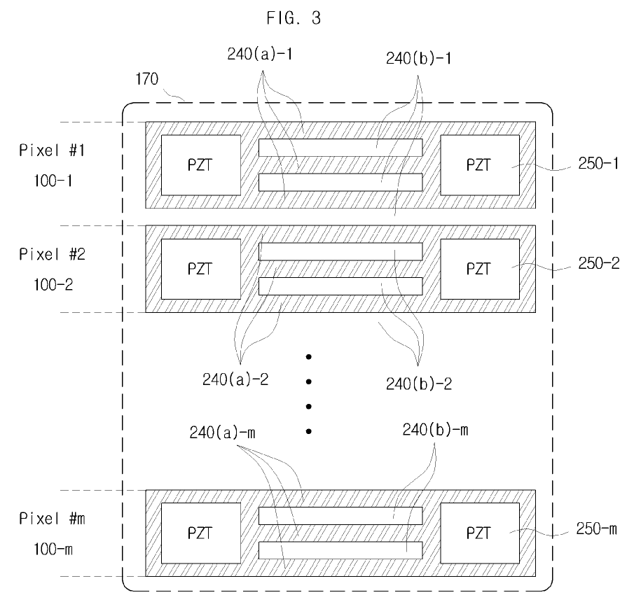

FIG. 3 shows an optical modulator that is included in a display device in accordance with an embodiment of the present invention.

Referring to FIG. 3, the optical modulator 170 is composed of an m number of micromirrors 100-1, 100-2, . . . , 100-m, each responsible for pixel #1, pixel #2, pixel #m. The optical modulator deals with image information with respect to 1-dimensional images of vertical or horizontal scanning lines (Here, it is assumed that a vertical or horizontal scanning line consists of an m number of pixels), while each micromirror 100-1, 100-2, . . . , 100-m deals with one pixel among the m pixels constituting the vertical or horizontal scanning line.

Thus, the light reflected and diffracted by each micromirror is later projected by a scanner 190 as a 2-dimensional image on a screen 195. For example, in the case of VGA 640*480 resolution, modulation is performed 640 times on one surface of an scanner (not shown) for 480 vertical pixels, to generate 1 frame of display per surface of the scanner.

While the description below of the principle of optical modulation concentrates on pixel #1, the same may obviously apply to other pixels.

In the present embodiment, it is assumed that the number of holes 240(b)-1 formed in the ribbon structure 240 is two. Because of the two holes 240(b)-1, there are three upper reflective layers 240(a)-1 formed on the upper portion of the ribbon structure 240. On the insulation layer 220, two lower reflective layers are formed in correspondence with the two holes 240(b)-1. Also, there is another lower reflective layer formed on the insulation layer 220 in correspondence with the gap between pixel #1 and pixel #2. Thus, there are an equal number of upper reflective layers 240(a)-1 and lower reflective layers per pixel, and as discussed with reference to FIG. 2, it is possible to control the luminosity of the modulated light using 0-order diffracted light or ±1-order diffracted light.

FIG. 4 is a schematic diagram illustrating an image generated on a screen by a diffraction type optical modulator array applicable to an embodiment of the invention.

Illustrated is a two-dimensional display 280-1, 280-2, 280-3, 280-4, . . . , 280-(k−3), 280-(k−2), 280-(k−1), 280-k generated when beams of light reflected and diffracted by an m number of vertically arranged micromirrors 200-1, 200-2, . . . , 200-m are reflected by the scanner and scanned horizontally onto a screen 195. One image frame may be projected with one revolution of the scanner. Here, although the scanning direction is illustrated as being from left to right (the direction of the arrow), it is apparent that images may be scanned in other directions (e.g. in the opposite direction).

The present invention can be applicable to a display device 10 which includes one dimensional optical modulator 170.

As described referring to FIG. 2 to FIG. 4, it is an optical modulator that modulates and generates an image using the light being irradiated from light source but the range of representable color depends on the wavelength of light being irradiated from laser light sources 100, 110, 120 in a display device 10.

A range of the wavelength of light being irradiated from laser light sources 100, 110, 120 determines the representable color that modulated and outputted by an optical modulator 170.

Therefore, below referring to FIG. 5, color representability in case of limiting wavelength of light being irradiated from laser light sources 100, 110, 120 is to be explained.

FIG. 5 shows a XY chromaticity diagram that indicates the color which is represented corresponding to a light wavelength from a light laser source in accordance with the present invention.

The XY chromaticity diagram in FIG. 5 indicates only hue and chroma, except luminosity and is made of two dimensional axis x and y. Thus, if luminosity are different but hues and chromas are same, colors may be located on the same coordinate.

In a horse's hoof shaped triangle of the XY chromaticity diagram, every representable color exists. Even if one mixes colors to increase luminosity, in the XY chromaticity diagram the color on the same XY coordinate merely has different luminosity.

Numerical values marked next to the edge of a horse's hoof shaped triangle of the XY chromaticity diagram represents locus of spectrum. Therefore according to wavelength of red, green and blue light to be mixed, range of a representable color in a horse's hoof shaped triangle of the XY chromaticity diagram may be different.

A display device in accordance with an embodiment of the present invention includes three laser light sources which are a green laser light source 100, a red laser light source 110 and a blue color laser light source 120. The red laser light source 110 is controlled to irradiate light in the wavelength range of 636 nm to 645 nm. Wavelength can be adjusted by an additional wavelength controller and in case of a solid laser, wavelength can be adjusted according to composition of a medium. But in a display device 10 in accordance with an embodiment of the present invention, how to adjust light wavelength is not limited to those methods, but adjustment of light wavelength in the range of 636 nm to 645 nm is a distinctive feature.

The green laser light source 100 is controlled to irradiate light in the wavelength range of 520 nm to 532 nm and the blue laser light source 120 is controlled to irradiate light in the wavelength range of 430 nm to 454 nm.

Each light from each laser light source 100, 110, 120 passes through a light expander 130, collimators 140a, 140b, 140c, and a line shaped light generator 160 and inserted to a optical modulator 170 and because each light from each laser light source 100, 110, 120 is limited as mentioned above, so light wavelength of the light having brightness for which each micromirror exists, is also 636 nm to 645 nm for red light or 520 nm to 532 nm for green light or 430 nm to 454 nm for blue light.

Therefore if this is analyzed in XY chromaticity diagram, in case of blue light, light wavelength is shorten and in case of red light, light wavelength is lengthen and therefore, larger range can be derived than prior color representative range. This results that colors in an image projected on a screen 195 by a light projector 180 is abundance.

Two triangles 510, 520 in a horse's hoof shaped figure of the XY chromaticity diagram represent ranges of color representability in prior art and in a display device in accordance with an embodiment of the present invention.

Referring to two triangles 510, 520, a triangle 520 which is range of color representability in a display device 10 is larger than a triangle 510 which is ranges of color representability in prior art.

This is summarized in table below.

| | triangle 510 | | | triangle 520 | | |
|---|---|---|---|---|---|---|
| | wave- | | | wave- | | |
| | length | X | Y | length | X | Y |
| Red | 635 nm | 0.57087 | 0.41435 | 640 nm | 0.58302 | 0.51254 |
| Green | 532 nm | 0.05573 | 0.08674 | 532 nm | 0.05573 | 0.58674 |
| Blue | 455 nm | 0.20328 | 0.06889 | 440 nm | 0.23475 | 0.03488 |

Referring to the table, in a display device 10, using the different wavelength of red light and blue light with a prior art, three vertex of triangle 520 is going close to exterior. This means that color in a triangle 520 is representable and better color representability can be acquired.

But triangle 520 is result of using just a part of light wavelength range in a display device 10 and if another wavelength out of the range of 636 nm to 645 nm, 520 nm to 532 nm and 430 nm to 454 nm, triangle 520 can have different size and location in the XY chromaticity diagram. But even if any wavelength out of the range of 636 nm to 645 nm, 520 nm to 532 nm and 430 nm to 454 nm is used, triangle 520 is larger than triangle 510 which indicates color representablility of prior art.

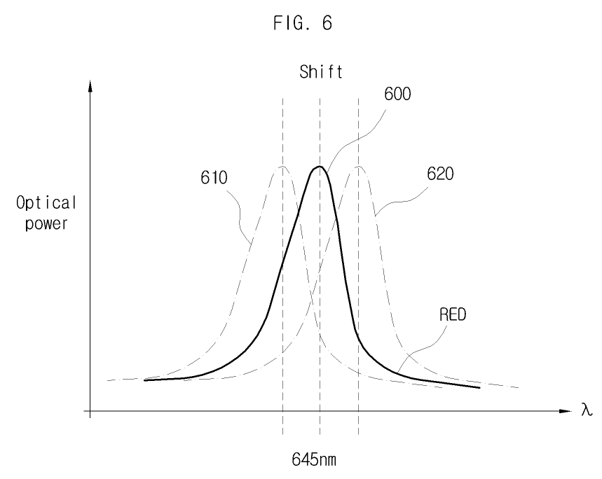

Beside improvement of color representablility in the XY chromaticity diagram in FIG. 5, another matter relating to temperature has to be considered as described in FIG. 6.

That is because in case of red light wavelength, light power decreases and a light wavelength is shifted by a certain ratio with increasing temperature. It is appreciated that those features would be because red light absorbs energy with increasing temperature by Wien's displacement law.

As described in FIG. 6, graph 600 which indicates optical power with respect to the wavelength of normal red light is shifted to graph 610 along wavelength axis with increasing temperature or to graph 620 along with decreasing temperature.

In this case, XY chromaticity diagram is affected, and color representablility is changed, so that a display device 10 has the problem of color representablility.

Also, red light is sensitive to temperature and wavelength is shifted intermittently and proper contrast is not expressed in an image projected on a screen 195. This problem occurs prominently in case of a diffraction type optical modulator.

Therefore, wavelength range that is stable to temperature is needed. So for proper power and constant wavelength of red light that is sensitive to temperature, red light is needed to be irradiated in wavelength range of 636 nm to 645 nm.

Comparing to the case of irradiating the red light that has wavelength below 636 nm or greater than 645 nm, in case of irradiating the red light that has wavelength 636 nm to 645 nm, it is verified experimentally that shift level of wavelength is decreased to 0.2 nm with 1 degree increasing in temperature.

So, in an embodiment of the present invention, using red laser light source which irradiates red light in the limited wavelength range 636 nm to 645 nm, the image with proper power and contrast can be achieved.

However, even if wavelength of red light is limited, temperature can be increased rapidly because of heat generation caused by the operation of inner elements in a display device or use of a display device for a long period of time. In this case, despite assumption that wavelength is shifted 0.2 nm with 1 degree increasing in temperature, wavelength shift of several nanometers is irresistible.

Therefore, even if a red laser light source which irradiates red light in the limited wavelength range 636 nm to 645 nm is used, it is needed to adjust a shifted wavelength or irradiate pre-wavelength shifted red light considering shift of wavelength.

Below, for this adjustment, a display method using a display device which further includes a temperature sensor and a wavelength controller in accordance with an embodiment of the present invention is described.

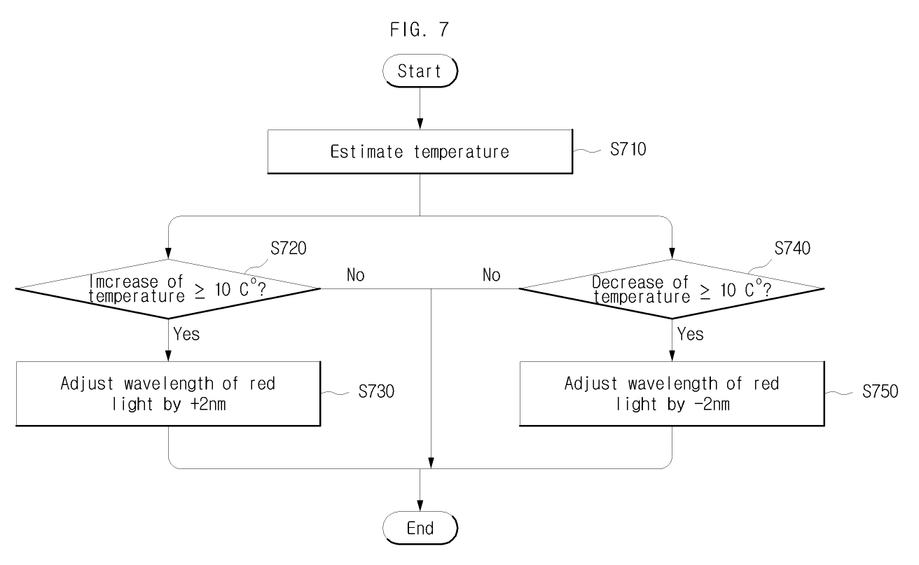

FIG. 7 is a flowchart that indicates the procedure of estimating temperature and adjusting light wavelength.

First, a display device 10 can further include a temperature sensor which senses the temperature of inside and outside of a display device 10 S610.

Temperature information determined by the temperature sensor is inputted into a image control module (not in picture) or a microprocessor and a image control module or a microprocessor determines whether increase of temperature is greater than 10 degree S620.

Determining whether increase of temperature is greater than 10 degree is merely one embodiment of the present invention, and an image control module or a microprocessor can be pre-programmed to determine whether increase of temperature is greater than 20 or 30 degree.

If increase of temperature is more than 10 degree, it is expectable that wavelength of red light is shorten by 2 nm (2 nm=10° C.×0.2 nm/° C.) and an image control module described referring to FIG. 1 can control a wavelength controller to shift by 2 nm S630. The wavelength controller can be included in a red laser light source 110 or can be existed as a separated part which receives red light from a red laser light source 110 and controls wavelength.

Therefore, red light that is inserted into an optical modulator 170 is normal red light of which wavelength is compensated by shift caused from 10 degree increase in temperature, so that an image on the screen can maintain to be projected with original contrast and constant power.

If it is determined that of the temperature is decreased by less than 10 degree S640, because wavelength is lengthen by 2 nm contrarily to increase of temperature, an image control module can control a wavelength controller to shift light wavelength by 2 nm S650.

In FIG. 7, the red laser light source which irradiates red light has been mainly described above, but if shift of light wavelength with changing temperature occurs in blue light or green light, it is obvious that same method can be used.

The aforementioned method of the present invention can be embodied in a program and stored in a recorded medium (e.g. a CD-ROM, a RAM, a ROM, a floppy disc, a hard disc, and an optical magnetic disc) that can be accessed by a computer.

As described, the present invention may provide the projected image by using three laser light source which irradiate red, green and blue light each of which wavelengths is limited to 636 nm to 645 nm, 520 nm to 532 nm or 430 nm to 454 nm.

Also, it may be another effect that red light is stable to changing temperature and a projected image with proper power and contrast can be achieved by limiting wavelengths of red to 636 nm to 645 nm.

It is to be appreciated that the present invention is not limited to the foregoing embodiments and that various permutations may be made by those skilled in the art without departing from the ideas of the invention.

What is claimed:

1. A display device, comprising:
a red laser light source which irradiates light in wavelength range of 636 nm to 645 nm; and
a light projector which modulates and projects the light on a screen.

2. The display device of claim 1, further comprising;
a blue laser light source which irradiates light in wavelength range of 430 nm to 454 nm.

3. The display device of claim 2, further comprising:
a green laser light source which irradiates light in wavelength range of 520 nm to 532 nm.

4. The display device of claim 1, further comprising:
a green laser light source which irradiates light in wavelength range of 520 nm to 532 nm.

5. The display device of claim 1, wherein the light projector comprises an optical modulator which diffracts and reflects the light.

6. The display device of claim 1, further comprising:
an expander which expands the light irradiated from a red laser light source;
a collimator which collimates the expanded light by the expander;
a line shaped light generator which receives the collimated light and outputs one dimensional line shaped light;
wherein the one dimensional line shaped light is inserted to the light projector.

7. The display device of claim 6, further comprising:
a blue laser light source which irradiates light in wavelength range of 430 nm to 454 nm;
a green laser light source which irradiates light in wavelength range of 520 nm to 532 nm;
first and second collimators; and
first and second reflectors;
wherein each light which the red laser light source the blue laser light source irradiates passes through the first collimator and the second collimator, respectively and is reflected by the first reflector and the second reflectors, respectively and pass through the a line shaped light generator and
light which the red laser light source irradiates passes through the expander.

8. The display device of claim 1, wherein the light projector further comprises an optical modulator which receives the light and modulates the brightness of light by diffracting and reflecting
and project lens which projects the modulated light on the screen.

9. The display device of claim 3, further comprising a wavelength controller that adjusts a wavelength range of light which is irradiated from at least one of red, green and blue laser light source.

10. The display device of claim 9, wherein the light projector further comprises an optical modulator which receives the light and modulates the brightness of light by diffracting and reflecting; and a temperature sensor,
wherein the wavelength controller that adjusts wavelength range of light which is irradiated from at least one of red, green and blue laser light source correspondingly to the temperature that the temperature sensor estimates.

11. The display device of claim 4, further comprising a wavelength controller that adjusts a wavelength range of light which is irradiated from at least one of red, green and blue laser light source.

12. The display device of claim 11, wherein the light projector further comprises an optical modulator which receives the light and modulates the brightness of light by diffracting and reflecting; and a temperature sensor,
wherein the wavelength controller that adjusts wavelength range of light which is irradiated from at least one of red, green and blue laser light source correspondingly to the temperature that the temperature sensor estimates.

13. A method at a display device for displaying a projected image on a screen by using laser light sources, the method comprising:
estimating inner or outer temperature of the display device at a temperature sensor which is included in the display device; and
outputting a control signal to a wavelength controller in the display device for adjusting wavelength range of the light which is irradiated from at least one of laser light sources correspondingly to the temperature that the temperature sensor estimates;
wherein in case that the laser light source irradiates red light, the wavelength is adjusted within the range of 636 nm to 645 nm and in case that the laser light source irradiates green light, the wavelength is adjusted within the range of 520 nm to 532 nm and in case that laser light source irradiates blue light, the wavelength is adjusted within the range of 430 nm to 454 nm.

14. Record medium that can be accessed by a computer which stores programs for a method at a display device for displaying a projected image on screen by using laser light sources, the method comprising:
estimating inner or outer temperature of the display device at a temperature sensor which is included in the display device; and
outputting control signal to a wavelength controller in the display device for adjusting wavelength range of light which is irradiated from at least one of laser light sources correspondingly to the temperature that the temperature sensor estimates;
wherein in case that the laser light source irradiates red light, the wavelength is adjusted within the range of 636 nm to 645 nm and in case that the laser light source irradiates green light, the wavelength is adjusted within the range of 520 nm to 532 nm and in case that the laser light source irradiates blue light, the wavelength is adjusted within the range of 430 nm to 454 nm.
